(19) United States
(12) Patent Application Publication
(10) Pub. No.: US 2026/0361385 A1
(43) Pub. Date: Nov. 12, 2026

(54) ORTHOGONAL FREQUENCY-DIVISION MULTIPLEXING (OFDM)-BASED BEAM REFINEMENT PROTOCOL (BRP) AND TRACKING FOR INTEGRATED MILLIMETER WAVE (IMMW)

(71) Applicant: Cisco Technology, Inc., San Jose, CA (US)

(72) Inventors: Matthew Aaron Silverman, Shaker Heights, OH (US); Ardalan Alizadeh, Milpitas, CA (US); Peiman Amini, Fremont, CA (US)

(21) Appl. No.: 19/671,996

(22) Filed: May 8, 2026

Related U.S. Application Data
(60) Provisional application No. 63/803,646, filed on May 10, 2025.

(51) Int. Cl. H04B 7/06; H04B 17/10; H04L 5/00

(52) U.S. Cl. CPC H04B 7/06958; H04B 17/10; H04L 5/0007

(57) ABSTRACT

Orthogonal Frequency-Division Multiplexing (OFDM)-based Beam Refinement Protocol (BRP) and tracking for Integrated Millimeter Wave (ImmW) may be provided. A first computing device may perform a Sector Level Sweep (SLS), over a first frequency spectrum, to determine a primary antenna beam configuration for communications with a second computing device over the first frequency spectrum. Next, the first computing device may transmit, over a second frequency spectrum, a plurality of test antenna beam configurations for communications with the second computing device over the first frequency spectrum. Then the first computing device may receive, from the second computing device, feedback associated with the plurality of test antenna beam configurations.

### RELATED APPLICATION

Under provisions of 35 U.S.C. § 119(e), Applicant claims the benefit of U.S. Provisional Application No. 63/803,646, filed May 10, 2025, which is incorporated herein by reference.

### TECHNICAL FIELD

The present disclosure relates generally to providing Orthogonal Frequency-Division Multiplexing (OFDM)-based Beam Refinement Protocol (BRP) and tracking for Integrated Millimeter Wave (ImmW).

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing Orthogonal Frequency-Division Multiplexing (OFDM)-based Beam Refinement Protocol (BRP) and tracking for Integrated Millimeter Wave (ImmW);

FIG. 2 is a flow chart of a method for providing OFDM-based BRP and tracking for ImmW; and

FIG. 3 is a block diagram of a computing device.

### DETAILED DESCRIPTION

### OVERVIEW

Orthogonal Frequency-Division Multiplexing (OFDM)-based Beam Refinement Protocol (BRP) and tracking for Integrated Millimeter Wave (ImmW) may be provided. A first computing device may perform a Sector Level Sweep (SLS), over a first frequency spectrum, to determine a primary antenna beam configuration for communications with a second computing device over the first frequency spectrum. Next, the first computing device may transmit, over a second frequency spectrum, a plurality of test antenna beam configurations for communications with the second computing device over the first frequency spectrum. Then the first computing device may receive, from the second computing device, feedback associated with the plurality of test antenna beam configurations.

Both the foregoing overview and the following example embodiments are examples and explanatory only and should not be considered to restrict the disclosure’s scope, as described and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

The Institute of Electrical and Electronics Engineers (IEEE) 802.11ad/ay standard defines a Sector Level Sweep (SLS) in order to allow for basic association of Millimeter Wave (mmW) band client devices. SLS may rapidly send multiple beacons beamformed to different sectors. Without this sweep, most association may fail because the range for the mmW band may be too poor without beamforming gain.

In addition to SLS, the IEEE 802.11ad/ay standard may also define Beam Refinement Protocol (BRP) as a second stage of beamforming training (e.g., after SLS), allowing for a more precise alignment than the initial wide-sector scan of SLS. BRP may use repeated Training (TRN) fields that are Golay sequences. BRP was designed for the Enhanced directional multi-Gigabit (EDMG) format and not for the Orthogonal Frequency-Division Multiplexing (OFDM) format. Accordingly, as described in greater detail below, embodiments of the disclosure may provide an OFDM-based beamforming refinement protocol for analog beamforming training.

Full BRP training may be done after association between an AP and a client device to find optimal analog beamforming, but may be repeated if either side of the link detects the need. An initiator (e.g., the AP) may determine the training sectors/beams that may be included in the training sequence as well as initiate an exchange with a responder (e.g., the client device).

Beam tracking may allow for updating analog or digital beamforming without the full SLS training. The initiator may request that the responder receive training in a next Physical Layer Convergence Procedure (PLCP) Protocol Data Unit (PPDU) that the initiator sends. TRN fields may be included in that PPDU. Those TRN fields may alternate between a primary beam (i.e., TRN_p) and a plurality of test beams (i.e., TRN_n). The responder may receive these, measures the power of each, and send a feedback report to the initiator that may indicate a best beam. Embodiments of the disclosure may provide an OFDM-based beamforming refinement protocol for BRP training.

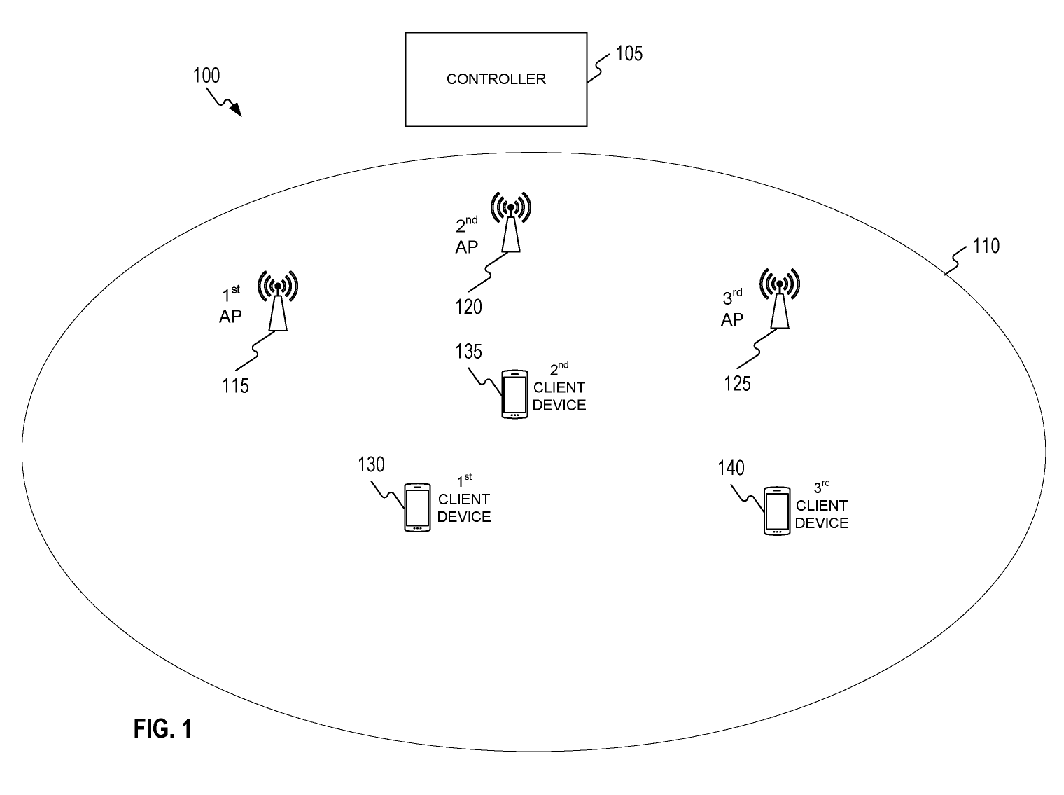

FIG. 1 shows an operating environment 100 for providing Orthogonal Frequency-Division Multiplexing (OFDM)-based Beam Refinement Protocol (BRP) and tracking for Integrated Millimeter Wave (ImmW). As shown in FIG. 1, operating environment 100 may comprise a controller 105 and a coverage environment 110. Coverage environment 110 may comprise, but is not limited to, a Wireless Local Area Network (WLAN) comprising a plurality of Access Points (APs) that may provide wireless network access (e.g., access to the WLAN for client devices). The plurality of APs may comprise a first AP 115, a second AP 120, a third AP 125. As described below, the plurality of APs may comprise any number of APs and is not limited to three.

The plurality of APs may provide wireless network access to a plurality of client devices (i.e., Station (STAs)) as they move within coverage environment 110. The plurality of client devices may comprise, but are not limited to, a first client device 130, a second client device 135, and a third client device 140. The plurality of client devices may comprise non-AP Multi-Link Devices (MLDs). Ones of the plurality of client devices may comprise, but are not limited to, a smart phone, a personal computer, a tablet device, a mobile device, a telephone, a remote control device, a set-top box, a digital video recorder, an Internet-of-Things (IoT) device, a network computer, a router, an Automated Transfer Vehicle (ATV), a drone, a vehicle, an autonomous vehicle, an Unmanned Aerial Vehicle (UAV), Virtual Reality (VR)/Augmented Reality (AR) devices, or other similar microcomputer-based device. Each of the plurality of APs may be compatible with specification standards such as, but not limited to, the Institute of Electrical and Electronics Engineers (IEEE) 802.11 specification standard.

The plurality of APs and the plurality of client devices may use Multi-Link Operation (MLO) where they simultaneously transmit and receive across different bands (or links) and channels by establishing two or more links to two or more AP radios. Accordingly, the plurality of APs and the plurality of client devices may comprise Multi-Link Devices (MLDs). These bands may comprise, but are not limited to the 2.4 GHz band, the 5 GHz band, the 6 GHz band, and the 60 GHz band. The two or more links on any given one of the plurality of client devices may be made with any one AP or with any combination of the APs.

The 2.4 GHz band, the 5 GHz band, and the 6 GHz band may be referred together as the sub 7GHz band. In addition to the sub 7GHz band, embodiments of the disclosure may operate in the mmW band. The mmW band may refer to an extremely high-frequency spectrum band (e.g., between 30 GHz and 300 GHz, often 60 GHz) delivering multi-gigabit, low-latency, short-range, line-of-sight connectivity. The mmW band may enable ultra-fast, high-capacity wireless networks, acting, for example, for massive data in crowded places and for Fixed Wireless Access (FWA).

Controller 105 may comprise a Wireless Local Area Network controller (WLC) and may provision and control coverage environment 110 (e.g., a WLAN). Controller 105 may allow first client device 130, second client device 135, and third client device 140 to join coverage environment 110. In some embodiments of the disclosure, controller 105 may be implemented by a Digital Network Architecture Center (DNAC) controller (i.e., a Software-Defined Network (SDN) controller) that may configure information for coverage environment 110 in order to provide OFDM-based BRP and tracking for ImmW.

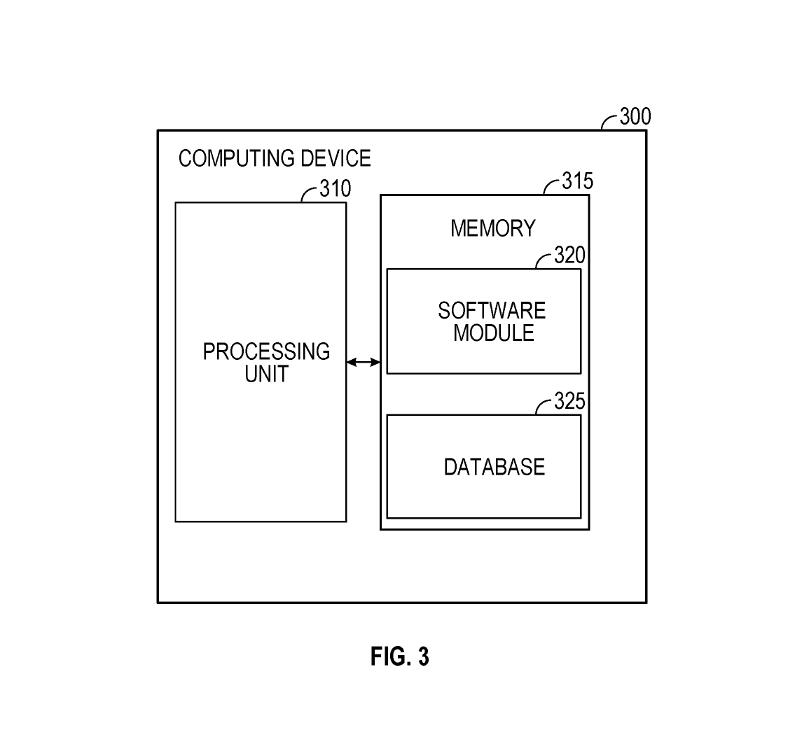

The elements described above of operating environment 100 (e.g., controller 105, first AP 115, second AP 120, third AP 125, first client device 130, second client device 135, or third client device 140) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 3, the elements of operating environment 100 may be practiced in a computing device 300.

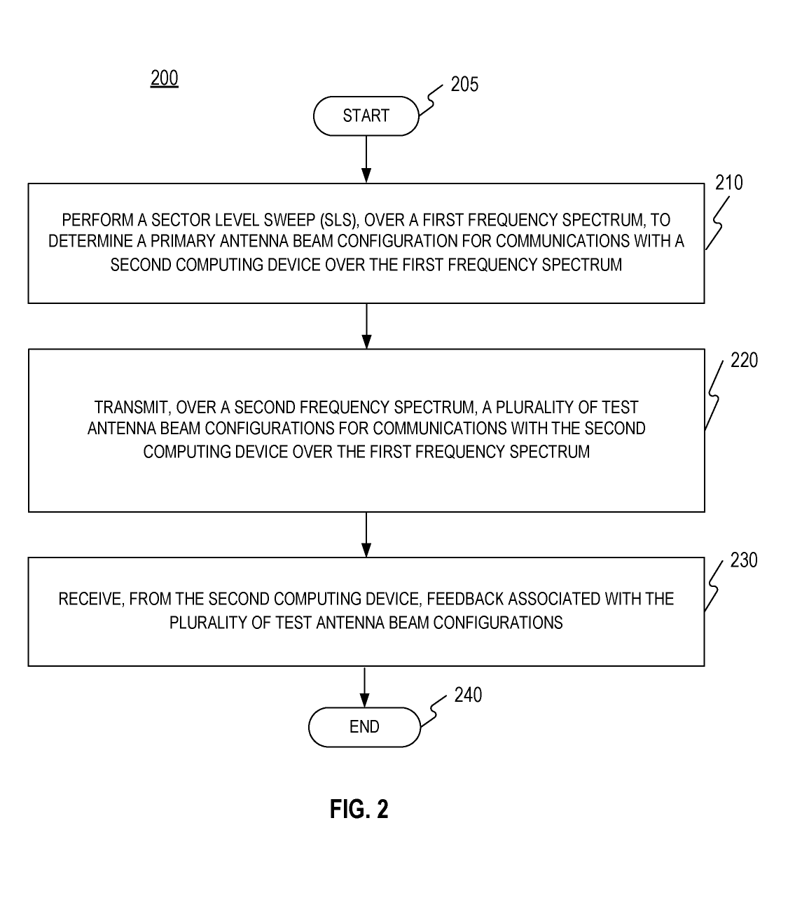

FIG. 2 is a flow chart setting forth the general stages involved in a method 200 consistent with embodiments of the disclosure for providing OFDM-based BRP and tracking for ImmW. Method 200 may be implemented using computing device 300 as described in more detail below with respect to FIG. 3 that may be embodied by first AP 115 or first client device 130. Ways to implement the stages of method 200 will be described in greater detail below.

Method 200 may begin at starting block 205 and proceed to stage 210 where first AP 115 may perform a Sector Level Sweep (SLS), over a first frequency spectrum, to determine a primary antenna beam configuration for communications with first client device 130 over the first frequency spectrum. For example, the first frequency spectrum may comprise a mmW band spectrum (e.g., a 60 GHz frequency spectrum). The SLS may comprise a beam-training phase in IEEE 802.11ad/ay mmW networks used to establish a high-gain, directional link between first AP 115 and first client device 130. The SLS may involve a search where devices sweep through different sectors (antenna beam patterns) to find a best transmitter-receiver pair, typically using a quasi-omnidirectional pattern for the receiver. This SLS process may allow both devices (first AP 115 and first client device 130) to determine best coarse-grained transmit and receive sector identifiers to use for subsequent communication.

From stage 210, where first AP 115 performs the SLS, method 200 may advance to stage 220 where first AP 115 may transmit, over a second frequency spectrum, a plurality of test antenna beam configurations for communications with first client device 130 over the first frequency spectrum. For example, the second frequency spectrum may comprise a sub 7 GHz frequency spectrum. The Beam Refinement Protocol (BRP) process of IEEE 802.11ad/ay may be used to optimize or refine antenna configurations (transmit/receive) after the initial SLS training. Rather than using the mmW frequency spectrum, embodiments of the disclosure may use the sub 7 GHz frequency spectrum for this optimization and refinement. The plurality of test antenna beam configurations may comprise configurations that fine-tune antenna weights and sectors, adapting to mobility of first client device 130 and/or improving link quality with first client device 130 in order to maximize signal-to-noise ratio for example.

The plurality of test antenna beam configurations may be transmitted over the second frequency spectrum (e.g., a sub 7 GHz frequency spectrum) in a packet comprising a PPDU. For example, the plurality of test antenna beam configurations may be transmitted in a Long Training Field (LTF) in the packet. The LTF may be included, for example, at a beginning of the packet (e.g., in the preamble) or at an end of the packet. The LTF may comprise, but is not limited to, a Very High Throughput Long Training Field (VHT-LTF), a High-Efficiency Long Training Field (HE-LTF), an Extremely High Throughput Long Training Field (EHT-LTF), or an Ultra-High Reliability Long Training Field (UHR-LTF).

Furthermore, the plurality of test antenna beam configurations may be transmitted over the second frequency spectrum in a Null Data Packet (NDP). For example, the plurality of test antenna beam configurations may be transmitted in a single NDP or in a respective corresponding plurality of Null Data Packets (NDPs). First AP 115 and first client device 130 may coordinate, over the second frequency spectrum, a time period over which the plurality of test antenna beam configurations may be transmitted for example.

Once first AP 115 transmits, over the second frequency spectrum, the plurality of test antenna beam configurations for communications with first client device 130 over the first frequency spectrum in stage 220, method 200 may continue to stage 230 where first AP 115 may receive, from first client device 130, feedback associated with the plurality of test antenna beam configurations. For example, first client device 130 may receive the plurality of test antenna beam configurations, measures the power of each of the plurality of test antenna beam configurations, and send a feedback report that may indicate a best beam. In other words, the feedback may indicate which one of the plurality of test antenna beam configurations provides a best connection between first AP 115 and first client device 130 as compared to other ones of the plurality of test antenna beam configurations.

Furthermore, first AP 115 may indicate to first client device 130 whether to send the feedback over the first frequency spectrum or the second frequency spectrum. Moreover, first client device 130 may indicate to first AP 115 whether the feedback will be sent over the first frequency spectrum or the second frequency spectrum. Once first AP 115 receives, from first client device 130, the feedback associated with the plurality of test antenna beam configurations in stage 230, method 200 may then end at stage 240.

FIG. 3 shows computing device 300. As shown in FIG. 3, computing device 300 may include a processing unit 310 and a memory unit 315. Memory unit 315 may include a software module 320 and a database 325. While executing on processing unit 310, software module 320 may perform, for example, processes for providing OFDM-based BRP and tracking for ImmW as described above with respect to FIG. 2. Computing device 300, for example, may provide an operating environment for controller 105, first AP 115, second AP 120, third AP 125, first client device 130, second client device 135, or third client device 140. Controller 105, first AP 115, second AP 120, third AP 125, first client device 130, second client device 135, or third client device 140 may operate in other environments and are not limited to computing device 300.

Computing device 300 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 300 may comprise any computer operating environment, such as hand-held devices, multiprocessor systems, microprocessor-based or programmable sender electronic devices, minicomputers, mainframe computers, and the like. Computing device 300 may also be practiced in distributed computing environments where tasks are performed by remote processing devices. The aforementioned systems and devices are examples, and computing device 300 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods’ stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 300 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure’s scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
performing a Sector Level Sweep (SLS), by a first computing device over a first frequency spectrum, to determine a primary antenna beam configuration for communications with a second computing device over the first frequency spectrum;
transmitting, by the first computing device over a second frequency spectrum, a plurality of test antenna beam configurations for communications with the second computing device over the first frequency spectrum; and
receiving, from the second computing device, feedback associated with the plurality of test antenna beam configurations.

2. The method of claim 1, wherein transmitting the plurality of test antenna beam configurations comprises transmitting the plurality of test antenna beam configurations in a Long Training Field (LTF).

3. The method of claim 2, wherein the LTF is at a beginning of a packet.

4. The method of claim 2, wherein the LTF is at an end of a packet.

5. The method of claim 2, wherein the LTF comprises one of a Very High Throughput Long Training Field (VHT-LTF), a High-Efficiency Long Training Field (HE-LTF), an Extremely High Throughput Long Training Field (EHT-LTF), and an Ultra-High Reliability Long Training Field (UHR-LTF).

6. The method of claim 1, wherein transmitting the plurality of test antenna beam configurations comprises transmitting the plurality of test antenna beam configurations in a Null Data Packet (NDP).

7. The method of claim 1, wherein transmitting the plurality of test antenna beam configurations comprises transmitting the plurality of test antenna beam configurations in a respective corresponding plurality of Null Data Packets (NDPs).

8. The method of claim 1, wherein the feedback indicates which one of the plurality of test antenna beam configurations provides a best connection between the first computing device and the second computing device as compared to other ones of the plurality of test antenna beam configurations.

9. The method of claim 1, wherein the second frequency spectrum comprises a sub 7 GHz frequency spectrum.

10. The method of claim 1, wherein the first frequency spectrum comprises a Millimeter Wave (mmW) band spectrum.

11. The method of claim 1, wherein the first frequency spectrum comprises a 60 GHz frequency spectrum.

12. The method of claim 1, wherein the first computing device indicates to the second computing device whether to send the feedback over one of the first frequency spectrum and the second frequency spectrum.

13. The method of claim 1, wherein the second computing device indicates to the first computing device whether the feedback will be sent over one of the first frequency spectrum and the second frequency spectrum.

14. The method of claim 1, wherein the first computing device comprise an Access Point (AP).

15. The method of claim 1, wherein the second computing device comprises a client device.

16. A system comprising:
a memory storage; and
a processing unit disposed in a first computing device and coupled to the memory storage, wherein the processing unit is operative to:
perform a Sector Level Sweep (SLS), over a first frequency spectrum, to determine a primary antenna beam configuration for communications with a second computing device over the first frequency spectrum;
transmit, over a second frequency spectrum, a plurality of test antenna beam configurations for communications with the second computing device over the first frequency spectrum; and
receive, from the second computing device, feedback associated with the plurality of test antenna beam configurations.

17. The system of claim 16, wherein the processing unit being operative to transmit the plurality of test antenna beam configurations comprises the processing unit being operative to transmit the plurality of test antenna beam configurations in a Long Training Field (LTF).

18. The system of claim 17, wherein the LTF is at one of a beginning of a packet and at an end of the packet.

19. A non-transitory computer-readable medium that stores a set of instructions which when executed perform a method executed by the set of instructions comprising:
performing a Sector Level Sweep (SLS), by a first computing device over a first frequency spectrum, to determine a primary antenna beam configuration for communications with a second computing device over the first frequency spectrum;
transmitting, by the first computing device over a second frequency spectrum, a plurality of test antenna beam configurations for communications with the second computing device over the first frequency spectrum; and
receiving, from the second computing device, feedback associated with the plurality of test antenna beam configurations.

20. The non-transitory computer-readable medium of claim 19, wherein transmitting the plurality of test antenna beam configurations comprises one of transmitting the plurality of test antenna beam configurations in a Null Data Packet (NDP) and transmitting the plurality of test antenna beam configurations in a respective corresponding plurality of NDPs.
